(19) United States
(12) Patent Application Publication
(10) Pub. No.: US 2004/0126061 A1
(43) Pub. Date: Jul. 1, 2004

(54) Holographic photonic integrated circuit

(76) Inventor: Arkady Bablumyan, San Diego, CA (US)

Correspondence Address: Eastman & Associates, Suite 1800, 707 Broadway Street, San Diego, CA, 92101, US

(21) Appl. No.: 10/613,538

(22) Filed: Jul. 3, 2003

Related U.S. Application Data
(60) Provisional application No. 60/393,923, filed on Jul. 3, 2002.

(51) Int. Cl. G02B 6/34

(52) U.S. Cl. 385/37; 385/14

(57) ABSTRACT

A holographic photonic integrated circuit includes a substrate with a ridge plane, a waveguide formed in the ridge plane haing an input and an output, a hologram formed in the ridge plane at least partially through the waveguide, and a CW light source wherein an optical signal entering the input is modulated by the CW light source to create a modulated output signal.

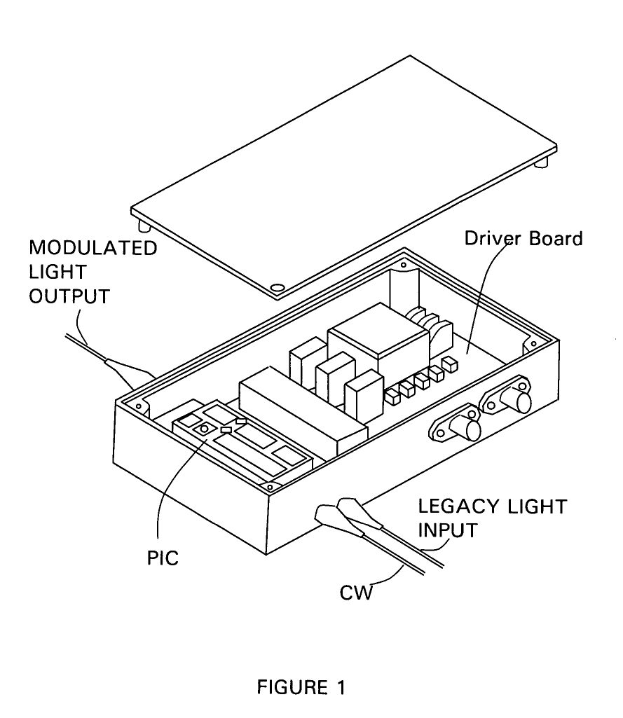

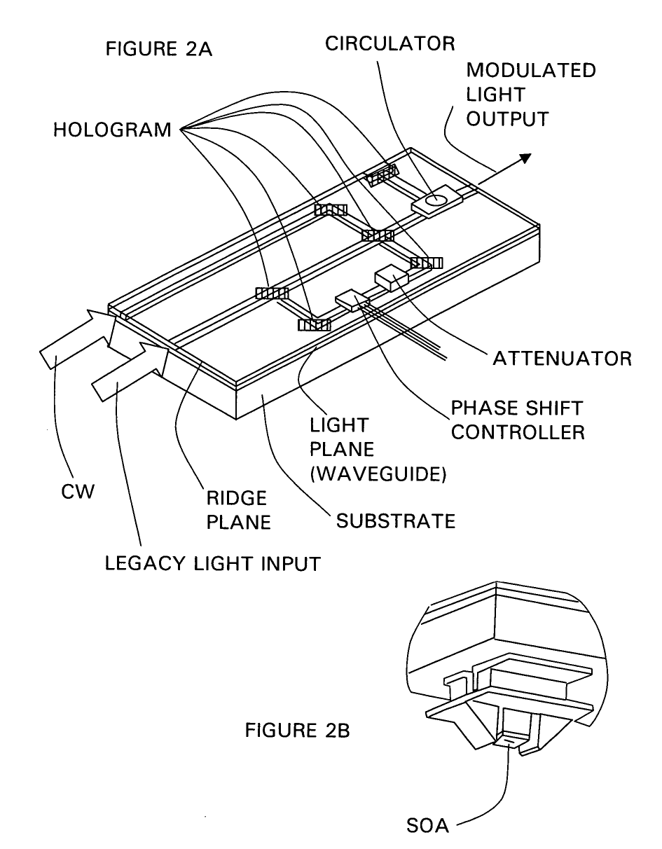

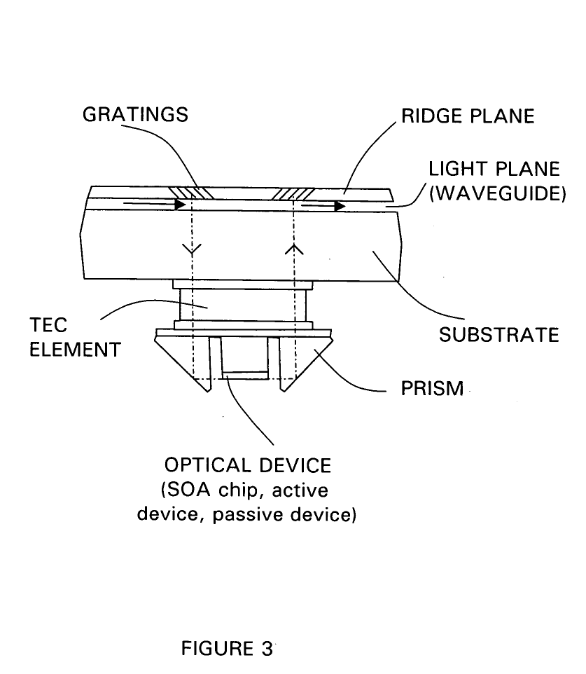

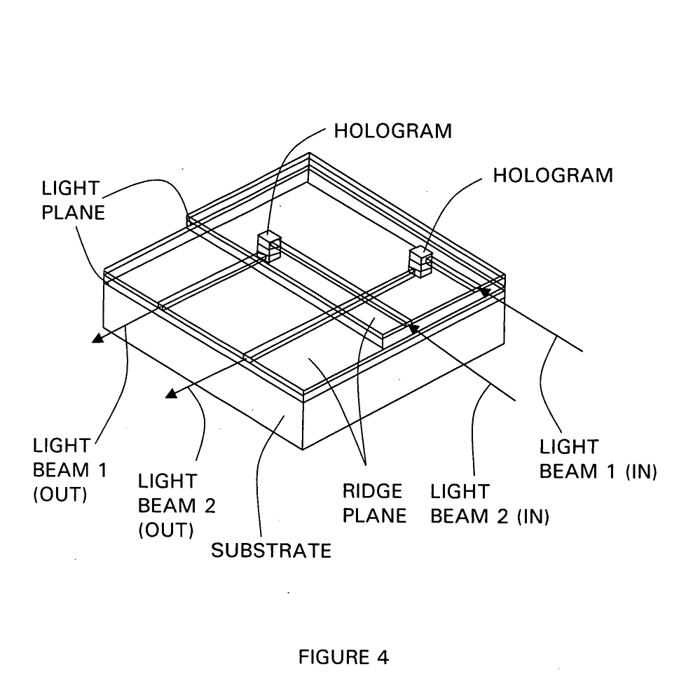

### RELATED APPLICATION

This application claims the benefit of priority from Provisional Patent Application Serial No. 60/393,923 filed Jul. 3, 2002, currently co-pending.

### ALL OPTICAL WAVELENGTH CONVERSION APPLICATIONS

OPTICAL PROCESSING & COMPUTATION

APPLICATIONS REQUIRING INTEGRATED OPTICS (NEAR UV TO FAR IR)

TELECOMMUNICATIONS

METRO ACCESS

INTERMEDIATE LINKS

LONG HAUL TRUNKS

WAVE LENGTH SWITCHES

=>SOLVE CONTENTION PROBLEM

REGENERATION

=>2R AMPLIFICATION & SHAPE

>3R AMPLIFICATION, SHAPE & RETIMING

1. A holographic photonic integrated circuit, comprising:
a substrate formed with a ridge plane;
a waveguide formed in said ridge plane having an input and an output;
a hologram formed in said ridge plane at least partially through said waveguide; and
a CW light source wherein an optical signal entering said input is modulated by said CW light source to create a modulated output signal.
